(19) United States
(12) Patent Application Publication
(10) Pub. No.: US 2023/0383378 A1
(43) Pub. Date: Nov. 30, 2023

(54) A CONTROL SYSTEM OF A COPPER EXTRACTION PROCESS

(71) Applicant: KEMIRA OYJ, Helsinki (FI)

(72) Inventors: Sampsa GREUS, Espoo (FI); Roderick ABINET, Frankfurt am Main (DE); Niko OSTROW, Espoo (FI); Jussi RUOTSALAINEN, Espoo (FI); Ruan PRETORIUS, Frankfurt am Main (DE)

(21) Appl. No.: 18/031,747

(22) PCT Filed: Oct. 28, 2021
(86) PCT No.: PCT/FI2021/050728

§ 371 Date: Apr. 13, 2023

(30) Foreign Application Priority Data
Oct. 30, 2020 (FI) 20206086

(51) Int. Cl. C22B 15/00; C22B 3/26; C25C 1/12

(52) U.S. Cl. CPC C22B 15/0084; C22B 15/0095; C22B 15/0071; C22B 3/26; C25C 1/12

(57) ABSTRACT

The invention relates to a control system for a copper extraction process having at least a leaching phase, a solvent extraction phase and an electrowinning phase, the leaching phase comprising a post leach thickener. The control system comprises first measuring units to measure volume and total suspended solids in an influent of the post leach thickener, and at least one second measuring unit to measure at least total suspended solids relating to effluent of the post leach thickener. The control system comprises also a control unit to receive measurements of the first measuring units and the second measuring units. The control unit forms a control signal to a polymer dosing into the influent of the post leach thickener, and another control signal to an organic solvent dosing in the solvent extraction phase.

### FIELD OF TECHNOLOGY

The invention relates to a control system, which is used in a copper extraction process. Especially, the invention relates to copper extraction process having at least a leaching phase, a solvent extraction phase and an electrowinning phase.

### PRIOR ART

A copper extraction process from ore comprises several steps. There are several different processes for the copper extraction. Usually, the ore is milled and then it goes through a flotation process. After the flotation there is a leaching phase. Before the leaching there can be a roasting phase and/or thickening phase of the flotation pulp of copper. After the leaching phase there is a solvent extraction phase and electrowinning. Effluent of the electrowinning phase is the final copper material of the copper extraction process.

Each phases and processes said above can comprise several subphases. Further, the processes depend of the copper ore achieved from a mine. Some of said phases may have control systems, but usually many control actions are based on manual measurements and manual dosing of different chemicals into the processes.

For example, in processes having at least the leaching phase, the solvent extraction phase and the electrowinning phase, the solvent extraction phase consumes organic solvent due to evaporation and with crud, which is removed from the solvent extraction. Therefore, the organic solvent is added into the extraction phase from time to time containing manual actions.

Another example is to dose polymer/s into the leaching phase. TSS measurements are made manually from the influent of the leaching process. The measurements are analyzed in a laboratory. Based on the analysis the polymer/sis dosed. The period between the dosings can be at least several hours. The processes have relatively long delays in order to react to the dosings done.

### SHORT DESCRIPTION

The object of the invention is to decrease the amount of the organic solvent, which is used in the solvent extraction phase of the copper extraction process. The object is achieved in a way described in the independent claims. Dependent claims illustrate different embodiments of the invention.

A control system according to the invention is for a copper extraction process having at least a leaching phase 9, a solvent extraction phase 15 and an electrowinning phase 16, the leaching phase comprising a post leach thickener 13. The control system comprises first measuring units M1, M2 to measure volume and total suspended solids in an influent of the post leach thickener 13, and at least one second measuring unit M3, M4, M5 to measure at least total suspended solids relating to effluent of the post leach thickener 13, The control system comprise also a control unit 31 to receive measurements of the first measuring units M1, M2 and the second measuring units M3, M4, M5. The control unit forms a control signal C1 to a polymer dosing into the influent of the post leach thickener 13.

An inventive method is used in controlling copper extraction process, which process has at least a leaching phase, a solvent extraction phase and an electrowinning phase, the leaching phase comprising a post leach thickening phase. The method comprises phases to measure volume and total suspended solids in an influent of the post leach thickening phase (61), to measure at least total suspended solids relating to effluent of the post leach thickening phase (62), to receive measurements of said measuring phases (63) by a control unit, and to form a control signal to a polymer dosing into the influent of the post leach thickening phase.

The idea of the invention is that by controlling the leaching phase efficiently in an automated way the amount of the solids in the effluent of the leaching phase can be decreased. The fluctuation of the amount of the solids in the effluent can also be decreased, which is also beneficial. Therefore, crud is not formed so much in the solvent extraction phase, which means that the solvent consumption decreases.

### LIST OF FIGURES

In the following, the invention is described in more detail by reference to the enclosed drawings, where

FIG. 1 illustrates an example of a known copper extraction process,

FIG. 2 illustrates an example of different embodiments of the invention,

FIG. 3 illustrates simple flow chart example of a control system according to the invention,

FIG. 4 illustrates another flow chart example of a control system according to the invention,

FIG. 5 illustrates an example of a control curve utilized by the invention, and

FIG. 6 illustrates a flow chart example of a method according to the invention.

### DESCRIPTION OF THE INVENTION

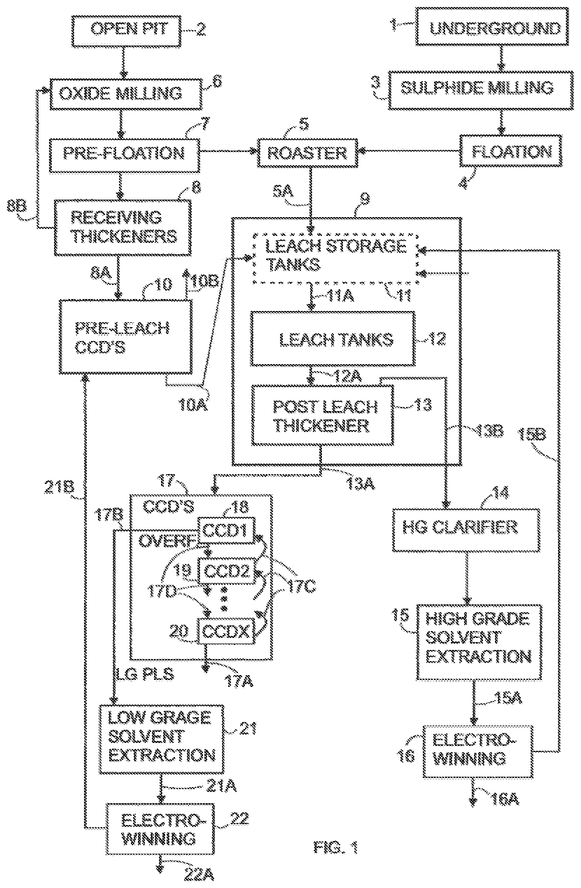

In order to understand the invention an example of a known copper extraction process is illustrated in FIG. 1. Ore is mined from an open-pit 2 or an underground mine 1. The ores from the open pit and from the underground mine are different, so they are feet to mills, which are dedicated to the copper oxide material mills 6 and copper sulphide material mills 3 respectively. The ore from the open pit is usually feet to the copper oxide mill, and the ore from the underground mill is usually feet to the copper sulphide mill.

After the mills, the milled ore is supplied to a flotation phase. The flotation is a process where mineral, like copper sulphide, is separated from gangue by taking advantage of difference in hydrophobicity. Surfactants and wetting agents is usually used. The milled copper sulphide material will be submitted to a conventional flotation process 4. For example, a copper concentrate of between 34% and 38% can be produced. The concentrate is then feet to a roaster 5 where the partial sulphating roast creates a copper product known as calcine that is readily soluble in acid. When roasting sulphide ore is heated to a high temperature in presence of air. The roasting is a metallurgical process where gas-solid reactions are involved. During roasting, the copper sulfide is converted to the calcine, which is an oxide.

On the other hand, the milled copper oxide material will be submitted to a single-stage flotation process, known as pre-flotation 7, where the fraction of sulphide minerals present in the ore will be separated from the predominantly copper oxide containing material. The copper sulphides concentrate from this flotation step is supplied to the roaster 5. The flotation tail is feet to receiving thickeners 8, which are parts of so-called displacement wash circuit.

The thickeners are used in a thickening process where for example solid-liquid mixture is processed. The idea is to separate most of the solids from water or liquor. The process utilizes gravitation. The overflow of the thickener is water/liquor. The underflow of the thickener is slurry containing most of the solids. The displacement wash is a process to wash solid-phase particles with a minimum amount of water.

The purpose of the receiving thickeners 8 is to remove as much as possible process water from the flotation tails that is received from the concentrator, ie. from the pre-flotation process 7. The feed from the concentrator can be pumped into receiving tanks that distribute the feed to the receiving thickeners. The underflow 8A from the thickeners 8 can comprise about 55-60% wt solids, which is transferred into a pre-leach thickener mixing tanks, here to a counter-current decantation (CCD) process 10. The overflow 8B (water/liquor) from the receiving thickeners is returned to the pre-flotation 7 via the oxide milling 6.

The counter current decantation process has several tanks, like thickener tanks, sequentially. The underflow of each tank feeds the next tank in the sequence. The overflow of each tank feeds the previous tank in the sequence. In other words, the water, or solution flows against the slurry having most of solids and impurities.

Here, the purpose of the pre-leach CCD 10 is also to displace water with low grade raffinate 21B from a low grade solvent extraction process 21 to reduce acid consumption by using residual acid in the low grade raffinate to consume some gangue minerals and leach a small amount of copper. In the pre-leach CCD 10, slurry flows counter current to the low grade raffinate solution used for washing of the slurry. The slurry (underflow) 10A from the pre-leach CCD is then transferred to a leach process 9. The overflow 10B from the pre-leach CCD is supplied to, for example, an iron precipitation tanks, which are not shown in FIG. 1.

The leaching process 9 illustrated in FIG. 1 comprise leach storage tanks 11, leach tanks 12 and a post leach thickener 13. It is worth to mention that this leaching process is just an example. Different leaching processes exist as well, and the invention can be used with them also. For example, heaps of calcine 5A from the roaster 5 and slurry 10 A from the pre-leach CCD can be made. Acid is sprayed on the heaps in order to leach materials. Further another example is to have the leaching process without the storage tanks, in which case the calcine 5A and the slurry 10A are feet to the leach tanks 12. A number of the leach tanks can also be varied depending on an implementation.

The purpose of the leaching process is to contact the copper minerals with a lixiviant, for example sulphuric acid, to dissolve the minerals of interest and transform them into the liquid phase as dissolved metal salts. The partially leached slurry 10A from the displacement wash, i.e. the pre-leach CCD, is pumped to the leach storage tanks 9 where it is brought into contact with the acidified high grade raffinate 15B from a high grade solvent extraction 15 and calcine 5A from the roaster/s 5. The storage leach slurry 11A is then pumped to the leach tanks 12 where the pH is to be controlled using acidified raffinate. The leach slurry 12A is then pumped to a post leach thickener 13. The leach process 9 may comprise several leach trains with several leach tanks, like two leach trains each with 6 leach tanks.

The purpose of the post leach thickener 13 is to separate the solid and liquid phases of the leached slurry stream. The target metals are now present in the liquid phase as dissolved metal sulphides along with other dissolved metals such as aluminium, magnesium, calcium and iron. The post leach thickener 13 is the point of separation between the high-grade pregnant leach solution (PLS) and the low grade PLS. The high grade PLS 13B is the overflow of the post leach thickener 13 and it is fed to a high-grade solvent extraction. The low grade PLS is the underflow (slurry) 13A of the post leach thickener 13 and it is fed to a low-grade solvent extraction.

As said, the post-leach thickener 13 is fed from the leach tanks 12, the slurry is diluted using a forced dilution system to reduce the feed-well slurry density to 5-10% wt solids. Flocculant is added in a thickener feed-well and/or in a thickener feed pipe. In the embodiment of FIG. 1 the thickener underflow, i.e. the low grade PLS is pumped to a CCD process 17, which is arranged be before the low-grade solvent extraction. The thickener overflow, i.e. the high-grade pregnant leach solution (PLS), is pumped to a high-grade clarifier/s 14, which is before the high-grade solvent extraction. As can be seen the copper extraction process may have additional processes between the leaching phase and the solvent extraction phase. The solvent extraction phase may comprise the process for the high-grade PLS and possibly the other process for the low-grade PLS as in the case of FIG. 1. Some implementations may not have processes for the low-grade solvent extraction.

The counter current decantation process 17 in the embodiment of FIG. 1 is used for other processes as well, which as such do not belong to the copper extraction.

The purpose of the counter current decantation tanks 17 is to displace the base metal containing solution with acidified cobalt barren solution, to recover up to 99.5% of the PLS through the 7 CCD stages, for example. The first tank/thickener CCD 1 18 is fed with the underflow slurry 13A from the post leach thickener 13 and the overflow solution from the second CCD 2 19. The importance of CCD 1 18 is that the metal containing solution from it, from the overflow 17B, is the feed to the low-grade solvent extraction process 21.

The tanks CCD 2 to CCD 6 fed with underflow from CCD (X−1) and overflow from CCD (X+1). The tank CCD 7 20 receives slurry from CCD 6 and cobalt barren solution from a cobalt precipitation plant that serves as a washable solution. The underflow 17A from CCD 7 is known as acidic tailings and is pumped to a tailings neutralization plant. The cobalt precipitation plant and the tailings neutralization plant are not illustrated in FIG. 1. As can be seen the overflows 17C of the CCD tanks flow against the underflows 17D.

As can be seen, the embodiment of FIG. 1 has the clarifier 14 between the post leach thickener/s 13 and the high-grade solvent extraction 15. Thickeners are more focused on to settle solids. Clarifiers are more focused on clear overflow liquor. The liquor is a name for solution, which is as free of suspended solids as possible. Depending on an implementation, clarifiers can be used or not used with thickeners for different combinations.

So, the high-grade solvent extraction process is fed with the pregnant leach solution, PLS, originating from the post-leach thickener 13. The purpose of the high-grade solvent extraction is to selectively extract copper from the PLS, leaving any other dissolved metals. Extraction of the copper from the PLS is achieved by using an extractant, i.e. organic solvent, that is synthesised to selectively bind to the dissolved copper ions. The solvent extraction phase has internal circulation of the organic solvent. Organic solvent is added from time to time in order to compensate loss the organic solvent via evaporation and crud. The copper containing organic extractant is called loaded organic.

After the solvent extraction 13 the high-grade loaded organic 15A is then stripped in a subsequent process 16 by contacting the loaded organic with an acidic solution called lean electrolyte. This process is an industrial electrolytic process, which is called as electrowinning. In electrowinning, a current is passed from an anode through the lean electrolyte containing copper. The copper is deposited in an electroplating process onto the cathode from where the pure copper can be gathered. The barren organic can be recycled to the extraction stage (not shown in FIG. 1). After the PLS have been stripped of the copper in solution, the acidic solution is now known as high grade raffinate 15B, that is returned to the leaching process 9 to be further acidified and used as a lixiviant.

The possible low-grade solvent extraction process 21 is fed with PLS originating from the CCD 1 18. The purpose of the low-grade solvent extraction process is to selectively extract copper from the low grade PLS, leaving behind any other dissolved metals. Extraction of the copper from the PLS is achieved by using an extractant, organic solvent, that is synthesised to selectively bind to the dissolved copper ions. The copper containing organic extractant is called loaded organic.

The low-grade loaded organic is then stripped in a subsequent electrowinning process 22. The barren organic is then recycled to the extraction stage. After the low grade PLS have been stripped of the copper in solution, the acidic solution is now known as low grade raffinate 21B, that is fed to the displacement wash CCDs, i.e. to the pre-leach CCD's 10.

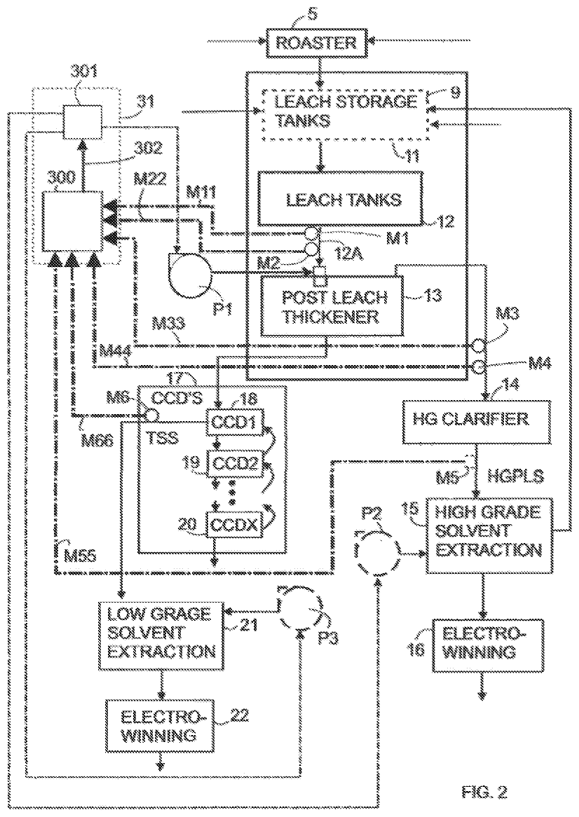

FIG. 2 illustrates different embodiments of the invention. The inventive control system is for a copper extraction process. The process has at least a leaching phase 9, a solvent extraction phase 15, 21 and an electrowinning phase 16, 22. The leaching phase comprises the post leach thickener as already said. The control system comprises first measuring units M1, M2 to measure volume and total suspended solids in an influent 12A of the post leach thickener 13. The control system further comprises at least one second measuring unit M3, M4, M5, M6 to measure at least total suspended solids relating to effluent 13B, 13A of the post leach thickener.

In addition, the control system comprises a control unit 31 to receive measurements ME1 . . . ME6 of the first measuring units M1, M2 and the second measuring units M3, M4, M5, M6, to form a control signal C1 to a polymer dosing into the influent 12A of the post leach thickener. The control signal is arranged to control feed pump P1. The feed pump P1 is arranged to feed polymer into the influent of the post leach thickener. By controlling the feed pump the dosing of the polymer can be kept at desired levels, and the solids in the PLS can be decreased. The fluctuation of the among of the solids in the PLS can also be decreased. Since the amount of crud, which is removed in the solvent extraction phase, depends on the solids in the PLS, the loss of the organic solvent is decreased due to the efficient control of the polymer dosing in the leaching phase.

Another embodiment of the invention is performed when the above said control arrangement is also arranged to form another control signal C2 to an organic solvent dosing in the solvent extraction phase 15. The other control signal may also comprise another control signal C3 to another solvent dosing if the copper extraction process has the already said low-grade solvent extraction 21. The other control signals are arranged to control feed pumps or valves P2, P3. The feed pump P2 is arranged to feed organic solvent to the high-grade solvent extraction process 15, the feed pump (or a valve) P3 to the low-grade solvent extraction process 21. By controlling the feed pumps the dosing of the organic solvent can be kept at desired levels without any notable fluctuations. In other words, when controlling the addition of the organic solvent, it can be made in shorter intervals between the dosing moments. This has also an effect that crud (and organic solvent bound with the crud) is removed less from the solvent extraction process.

The control unit 31 is arranged to keep the measurements of the second measuring unit M3, M5, M6 relating to the total suspended solids, TSS, at a setpoint value by controlling the polymer dosing. In other words, when the measured TSS relating to the effluent of the post-leach thickener is kept at the desired value, when the post-leach thickener 13 runs properly, it also affects to the dosing rate for the organic solvent in the solvent extraction phase. So, the TSS level in the overflow 13B of the post leach thickener is kept at the setpoint, and therefore the high-grade solvent extraction process 15 can be run with less amount of the organic solvent, because the crud forming and crud fluctuation of the extraction process is minor. As said, the control unit 31 can also be arranged to utilize the setpoint value to form the control signal to the organic solvent dosing. The above said matters applies also to the low-grade solvent extraction process 21, if it is used in the copper extraction process.

FIG. 3 shows a simplified flow chart of the inventive control system. The first measuring units (see FIG. 2) measure volume and total suspended solids in an influent of the post leach thickener. As said the post leach thickener is in the leaching phase 32. The control unit 31 is arranged to receive the measurements 35. At least one second measuring unit is arranged to measure at least total suspended solids relating to effluent 39 of the post leach thickener. The effluent is influent to the solvent extraction phase 33. The control unit 31 is arranged to receive the measurements 35 of the second measurement unit/s. The control unit is also arranged to form a control signal 37 to a polymer dosing into the influent of the post leach thickener. As said, another inventive control system can be provided when the control unit arranged to form another control signal 38 to an organic solvent dosing in the solvent extraction phase 33. After the solvent extraction 33 the high-grade loaded organic is stripped in the electrowinning phase 34 in order to obtain pure copper 40.

As can be noted in FIGS. 2 and 3 the copper extraction process, wherein the invention is used, comprises at least the leaching phase, the solvent extraction phase, and the electrowinning phases. In practice there are further phases as can be seen in FIG. 1, since the original source of the copper is the ore from a mine. However, it may also be possible that the material is transported to a copper extraction plant having the said three phases. Further, it is worth to note that each phase may comprise several subphases. FIG. 1 shows the leaching phase, the solvent extraction phase, and the electrowinning phase generally. FIG. 2 shows the phases and possible subphases more specifically. All details or real implementations are not shown since they would make the description of the invention unnecessary difficult to follow and they are considered unnecessary to describe the invention.

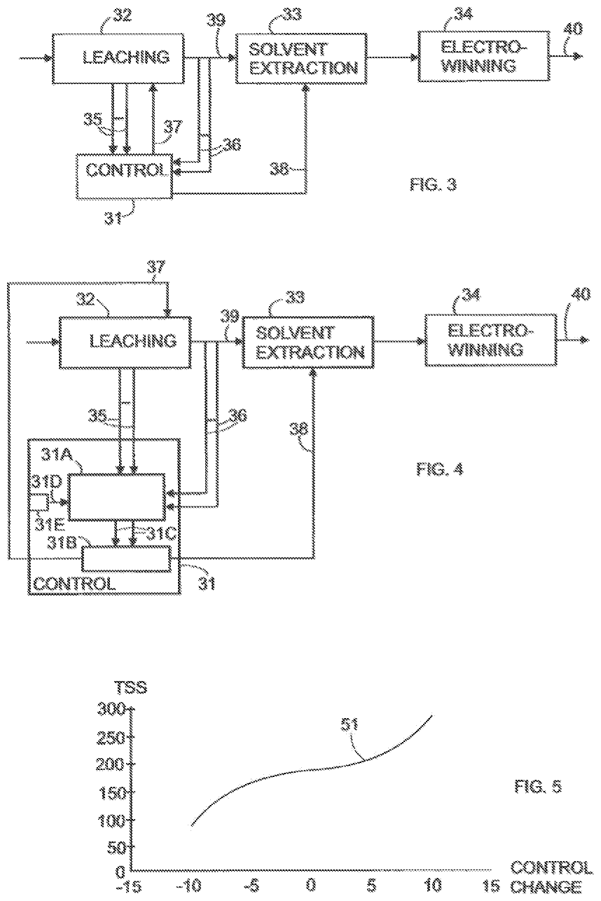

FIG. 4 shows another example of the invention. The control unit 31 is illustrated in more detail. The control unit has a calculation unit 31A, which is arranged to receive measurements 35, 36 of the first measurement units M1, M2 and the second measurement units M3, M4, M5, M6. The calculation unit uses a suitable control algorithm in order to make a control change signal/s 31C. The control algorithm used can be based on a neural network, linguistic equations, fuzzy logic, etc. Also more traditional control algorithms, PI, PID etc. may be used, as well as tables. The control change signal/s 31C is transformed into the control signal/s 37, 38 by a transformation unit 31B in order that it/they can control the pump P1, for dosing a correct amount of polymer.

In addition, the control change signals may also relate to control dosing/addition of the organic solvent, in which case The control change signals 31C are transformed into the control signal/s 37, 38 by a transformation unit 31B in order that it/they can control the pumps P1, P2, P3 for dosing a correct amount of polymer ans organic solvent.

In other words, the transformation unit 31B convert the control change signals 31C to be suitable for the pumps.

The calculation unit is also arranged to use a setup value 31D for a desired parameter. In the invention the parameter is a TSS value relating to the effluent of the post leach thickener 13. This TSS value is kept at the setpoint value 31D by the control unit. If the measured TSS value differs from the setpoint value, the control unit gives the control signal 37 in order to change the dosing of the polymer by controlling the pumping rate of the pump P1. More precisely the calculation unit 31A calculates the control change signal 31C base on said difference/s between the setpoint TSS value and the measured TSS value, and the transformation unit 31B convert the control change signal to the controls signal 37, which is suitable for the pump P1. The polymers are used as flocculants in the post-leach thickener.

The setpoint value 31D is set for the use of the calculation unit 31A by taking into account process conditions of the post leach thickener in order to keep the post leach thickener running properly. The control unit 31 may have a setup unit 31E for making and adjusting the setup value. The setup unit can be arranged to take into account several parameters.

When the post-leach thickener runs properly, and the TSS value relating to effluent of the post-leach thickener is kept at the setpoint value, it also affect to the solvent extraction process 33 so that extraction process runs more stable and therefore the dosing/addition of the organic solvent into the extraction process is more steady. Crud is formed less in the solvent extraction phase, and therefore the loss of the organic solvent is lesser. This has an effect that the organic solvent can actually be dosed less. Further, in the steady process the organic solvent can be used more efficiently. So, the control unit is arranged to utilize the setpoint value 31D for the TSS value relating to the effluent of the post leach thickener.

The setpoint value may also be used to make the control signal 38 for the pump/valve P2 (and also to P3) to dose/add the organic solvent. There is a correlation between the said TSS value and the dosing/adding of the organic solvent. This correlation can be handled by a simple table or a more complicated control algorithm like those mentioned above.

FIG. 5 shows an example of controlling the polymer dosing (i.e. flocculant dosing) in the influent of the post leach thickener based the TSS measurement of the effluent. The control utilizes a 3rd degree polynomial function 51 illlustrated as a curve in FIG. 5. So, the control unit 31, more precisely the calculation unit 31A, comprises the 3rd degree polynomial function in order to form a control change signal 31C as response to the measurements of the second measuring units, which control change signal is utilized to form the control signal 37 to polymer dosing. The control change values are at the horizontal axis, and the TSS measurement values at the vertical axis in FIG. 5. The setpoint for the TSS value is 185 when the control change signal zero. If the TSS measurement values differs from the setpoint value then the control unit form a control change signal 31C, which value can be seen in FIG. 5. For example, if the measured TSS value is 285 the control change signal is 10. If the measured TSS value is 205 the control change signal is 5. If the measured TSS value is 165 the control change signal is −5. If the measured TSS value is 85 the control change signal is −10. The 3rd degree polynomial function has been found to represent properly process behaviour of the post leach thickener between the effluent TSS value and the control change value. Other arrangements than the 3rd degree polynomial function for making the control signal change signal can also used, like linguistic equations or neural networks.

As said, FIG. 2 illustrates different embodiments of the invention. The first measuring units has a volume measurement device M1 and a turbidity or TSS measurement device M2. The turbidity measurement can be used for getting a TSS measurement by using a special calculation which convert the measured turbidity value to the TSS value. This can be either in the measurement device M2 or in the control unit 31. The same applies to the second measuring unit/s, so it/they can also be a turbidity or TSS measurement device M3, M5, M6. The second measuring units may also be arranged to measure volume of the overflow of the post leach thickener. So the second measuring devices may comprise a volume measuring device/unit. A volume measuring device measures a flow volume rate.

The polymer dosing is arranged to supply the polymer into a feed pipe or a feed well of the post least thickener. The polymer dosing is controlled by controlling the pumping rate of the pump P1.

As illustrated in FIGS. 1 and 2 the copper extraction process may also have a clarifier unit 14, in which case the overflow 13B of the post leach thickener being an influent to the clarifier unit. The control system may further comprise a further second measuring unit M5, which is arranged to measure turbidity or TSS in the effluent of the clarifier unit. The measuring unit M5 may be used instead of the measuring unit M3, or with the measuring unit. The control unit is arranged to take into account a location the measuring unit/s. The second measuring unit/s can be arranged to measure turbidity or TSS in an effluent of the clarifier unit 14, and a further second measuring unit, can is arranged to measure volume of the effluent of the clarifier unit.

Above, it is mostly described the overflow of the post leach clarifier unit, being the effluent of the post leach clarifier. However, the effluent can also be considered to comprise the underflow 13A of the process in question, in this case the underflow of the post leach thickener. As can be seen in FIG. 2 the copper extraction process may have also a counter current decantation unit 17 having several counter current decantation tanks 18, 19, 20. In this example, the underflow 13A of the post leach thickener is an influent to the counter current decantation unit 17, and the control system further comprises a further second measuring unit M6, which is arranged to measure turbidity or TSS in an overflow of the first current decantation tank 18.

So, the solvent extraction phase comprises a high grade solvent extraction unit 15 having an influent from the leaching phase, more precisely from the overflow 13B of the post least thickener. As said, the control unit 31 may also be arranged to form the control signal C2 to the organic solvent dosing to the high grade solvent extraction unit 15.

In addition, the solvent extraction phase may also comprise a low grade solvent extraction unit 21 having an influent 17B from the overflow of the first current decantation tank 18 of the counter current decantation unit 17 The control unit may further arranged to form the control signal C3 to the organic solvent dosing to the low grade solvent unit 21.

The control unit 31 illustrated in FIGS. 2, 3 and 4 can be a local unit or a distributed unit having at least a first control unit 300 and a second control unit 301, where the first control unit is arranged to receive measurements M11, M22, M33, M44, M55, M66 of the first measuring units M1, M2 and the second measuring units M3, M4, M5, M6, and to form the control change signal. The control change signal is for the polymer dosing pump P1 of the post leach thickener.

As said, in the other embodiment the control unit can be arranged to form other control change signal. The other control change signals are for the pump/s or valve/s P2, P3 dosing the organic solvent.

The first control unit 330 is in communication with the second control unit 301, which second control unit is arranged to utilize control change signal (and the other control change signals) to form the control signal to polymer dosing (and the organic solvent dosing).

The control unit 31 can be in the location of the copper extraction process, but as said it can also have a distributed structure. For example, the second control unit 301 may be situated with the copper extraction plant, and the first control unit 300 can be in a server in another location. In the distributed structure the communication between the measuring devices M1 . . . M6 and the first control unit, and between the first control unit 300 and the second control unit 301, are via a communication network/s. The communication network can be wireless network like a mobile phone network, or fixed network, or a combination of different communication networks. The functions of the first control unit can be served as a cloud service. It is practical to have a local control unit 301 to provide the control signals C1, C2, C3 to the local devices like the pumps in the case of FIG. 2. The whole control unit 31 may also be located in a server somewhere, i.e. implemented as a cloud service. In this case the control signals to the local devices are also transmitted via the communication network/s. The functions of the control unit can be achieved by hardware, software or their combination, for example by printed circuits and/or software entities.

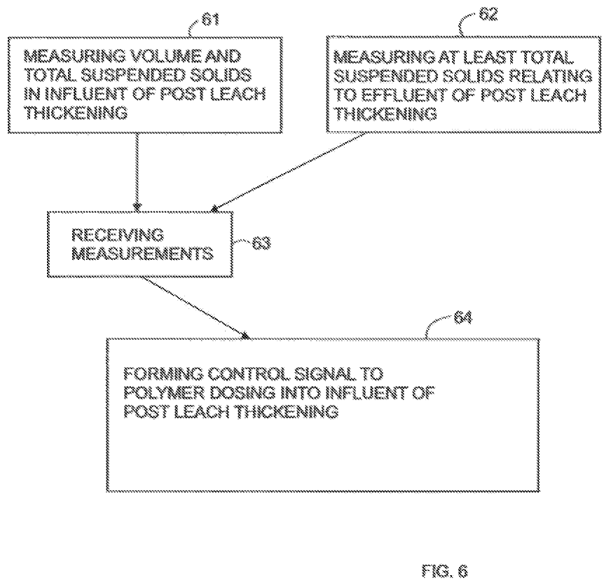

FIG. 6 illustrates the inventive method. The method is for controlling copper extraction process having at least a leaching phase, a solvent extraction phase and an electrowinning phase, wherein the leaching phase comprising a post leach thickening phase. The method comprises phases to measure volume and total suspended solids 61 in an influent of the post leach thickening phase, and to measure at least total suspended solids 61 relating to effluent of the post leach thickening phase. The method further comprises phases to receive measurements 63 of said measuring phases by a control unit, and to form 64 a control signal to a polymer dosing into the influent of the post leach thickening phase. The method may also comprise a phase to form another control signal to an organic solvent dosing in the solvent extraction phase by the control unit.

The method can be arranged to keep the measurements of the total suspended solids relating to effluent of the post leach thickening phase at a setpoint value by the control signal. The control unit may further arranged to utilize the setpoint value to form the other control signal to the organic solvent dosing as described above.

The method can also be arranged to utilize a 3rd degree polynomial function in order to form a control change signal as response to the measurements of the total suspended solids relating to effluent of the post leach thickening phase, which control change signal is utilized to form the control signal to polymer dosing as described above.

The inventive system and method are used in the copper extraction process having the leaching, solvent extraction and electrowinning phases. The leaching is in atmospheric condition. The invention makes it possible to consume less organic solvent in the solvent extraction phase than in know implementations. The organic solvent is the most expensive chemistry utilized in the copper extraction. The amount of the organic solvent removed with the crud correlates to the amount of suspended solids that pass to the solvent extraction unit/s. The solids, which pass via the effluent of the post leaching are decreased in the invention. So suitable locations to the turbidity or TSS measurement devices have been selected. The turbidity or the TSS measurement devices are arranged to withstand the harsh conditions (low pH) of a mining solution.

The invention is used for thickening and clarifier units to optimize the dosing of polymers for solid liquid separation. TSS levels are used as an indication of treatment efficacy. The TSS level is kept as low as possible, taking into account that the post leach thickener runs properly. The TSS level also, as already said, has effect for the required dosing/addition of the organic solvent for the solvent extraction unit/s.

Depending on the implementations of copper extraction plants, there can be many post leach thickeners and clarifiers and also many solvent extraction units.

It is evident from the above that the invention is not limited to the embodiments described in this text but can be implemented in many other different embodiments within the scope of the independent claims.

1. A control system of a copper extraction process, the process having at least a leaching phase, a solvent extraction phase and an electrowinning phase, the leaching phase comprising a post leach thickener, wherein the control system comprises
first measuring units to measure volume and total suspended solids in an influent of the post leach thickener,
at least one second measuring unit to measure at least total suspended solids relating to effluent of the post leach thickener,
a control unit to receive measurements of the first measuring units and the second measuring units, to form a control signal to a polymer dosing into the influent of the post leach thickener.

2. The control system according to claim 1, wherein the control unit is arranged to keep the measurements of the second measuring unit relating to the total suspended solids at a setpoint value by controlling the polymer dosing.

3. The control system according to claim 2, wherein the control unit comprises a 3rd degree polynomial function in order to form a control change signal as response to the measurements of the second measuring units, which control change signal is utilized to form the control signal to polymer dosing.

4. The system according to claim 3, wherein the first measuring units have a volume measurement device and a turbidity or TSS measurement device.

5. The control system according to claim 4, wherein the second measuring unit is a turbidity or TSS measurement device.

6. The control system according to claim 4, wherein the polymer dosing is arranged to supply the polymer into a feed pipe or a feed well of the post least thickener.

7. The control system according to claim 4, wherein the second measuring unit is arranged to measure turbidity or TSS in an overflow of the post leach thickener.

8. The control system according to claim 7, wherein the control system comprises a further second measuring unit, which is arranged to measure volume of the overflow of the post leach thickener.

9. The control system according to claim 7, wherein the copper extraction process has also a clarifier unit, the overflow of the post leach thickener being an influent to the clarifier unit, and the control system further comprises a further second measuring unit, which is arranged to measure turbidity or TSS in an effluent of the clarifier unit.

10. The control system according to claim 7, wherein the copper extraction process has also a clarifier unit, the overflow of the post leach thickener being an influent to the clarifier unit, and the second measuring unit is arranged to measure turbidity or TSS in an effluent of the clarifier unit.

11. The control system according to claim 10, wherein it comprises a further second measuring unit, which is arranged to measure volume of the effluent of the clarifier unit.

12. The control system according to claim 2, wherein the control unit is also arranged to form another control signal to an organic solvent dosing in the solvent extraction phase.

13. The control system according to claim 12, wherein the control unit is arranged to utilize the setpoint value to form the control signal to the organic solvent dosing.

14. The control system according to claim 4, wherein the copper extraction process has also a counter current decantation unit having several counter current decantation tanks, an underflow of the post leach thickener being an influent to the counter current decantation unit, and the control system further comprises a further second measuring unit, which is arranged to measure turbidity or TSS in an overflow of the first current decantation tank.

15. The control system according to claim 12, wherein the solvent extraction phase comprises a high grade solvent extraction unit having an influent, the influent having a source from the overflow of the post-leach thickener, and the control unit is arranged form the control signal to the organic solvent dosing to the high grade solvent unit.

16. The control system according to claim 15, wherein the solvent extraction phase comprises a low grade solvent extraction unit having an influent, the influent having a source from the overflow of the first current decantation tank of the counter current decantation unit, and the control unit is further arranged form the control signal to the organic solvent dosing to the low grade solvent extraction unit.

17. The control system according to claim 10, wherein the control unit is distributed having at least a first control unit and a second control unit, where the first control unit is arranged to receive measurements of the first measuring units and the second measuring units, and to form the control change signal, and be in communication with the second control unit, which second control unit is arranged to utilize control change signal to form the control signal to polymer dosing.

18. The control system according to claim 12, wherein the control unit is distributed having at least a first control unit and a second control unit, where the first control unit is arranged to receive measurements of the first measuring units and the second measuring units, and to form the control change signal and other control change signals, and to be in communication with the second control unit, which second control unit is arranged to utilize control change signal and the other control change signals to form the control signal to polymer dosing and the organic solvent dosing.

19. A method of controlling copper extraction process having at least a leaching phase, a solvent extraction phase and an electrowinning phase, the leaching phase comprising a post leach thickening phase, wherein the method comprises phases
to measure volume and total suspended solids in an influent of the post leach thickening phase,
to measure at least total suspended solids relating to effluent of the post leach thickening phase,
to receive measurements of said measuring phases by a control unit, and
to form a control signal to a polymer dosing into the influent of the post leach thickening phase,
and to form another control signal to an organic solvent dosing in the solvent extraction phase by the control unit.

20. The method according to claim 1, wherein the method comprises also a phase to form another control signal to an organic solvent dosing in the solvent extraction phase by the control unit.

21. The method according to claim 19, wherein the control unit is arranged to keep the measurements of the total suspended solids relating to effluent of the post leach thickening phase at a setpoint value by the control signal.

22. The method according to claim 20, wherein the control unit is arranged to keep the measurements of the total suspended solids relating to effluent of the post leach thickening phase at a setpoint value by the control signal, and the control unit is further arranged to utilize the setpoint value to form the other control signal to the organic solvent dosing.

23. The control system according to claim 1, wherein the control unit is arranged to utilize a 3rd degree polynomial function in order to form a control change signal as response to the measurements of the total suspended solids relating to effluent of the post leach thickening phase, which control change signal is utilized to form the control signal to polymer dosing.
